(19) United States
(12) Patent Application Publication
(10) Pub. No.: US 2020/0314970 A1
(43) Pub. Date: Oct. 1, 2020

(54) HOB DEVICE

(71) Applicant: BSH Hausgeräte GmbH, Munich (DE)

(72) Inventors: Enrique Delgado Sancho, Zaragoza (ES); Clara Fuertes Pinol, Zaragoza (ES); Javier Herrera Rodriguez, Zaragoza (ES); Jorge Mena Ramirez, Zaragoza (ES); Daniel Palacios Tomas, Zaragoza (ES)

(21) Appl. No.: 16/955,118

(22) PCT Filed: Nov. 26, 2018
(86) PCT No.: PCT/IB2018/059302

§ 371 Date: Jun. 18, 2020

(30) Foreign Application Priority Data
Jan. 8, 2018 (ES) P201830011

(51) Int. Cl. H05B 6/06; F24C 15/10; F24C 7/08; H05B 6/12

(52) U.S. Cl. CPC H05B 6/062; F24C 15/10; H05B 2213/03; H05B 6/1218; F24C 7/083

(57) ABSTRACT

A hob device, in particular induction hob device, includes a placement plate configured for placement of an item of cookware, at least two heating units configured to heat the item of cookware, and an illumination strip including a lighting unit and configured to indicate in an operating state an extension of the item of cookware in relation to at least one direction.

The invention relates to a hob device as claimed in the preamble of claim 1 and a method for operating a hob device as claimed in the preamble of claim 15.

Already known from the international patent application WO 2017/093850 A1 is a hob device, which has a placement plate embodied as a hob plate and eight heating units, which are arranged below the hob plate in an installed position. The hob device has a plurality of illumination strips. Two illumination strips are assigned to a single heating unit in each case. In this context, the illumination strips assigned to the heating unit are arranged on mutually opposing sides of the heating unit in relation to a transverse direction. In an operating state, by means of a varying intensity in a depth direction of illumination strips which are adjacent in the depth direction, the illumination strips indicate a variation of a heating output of heating units which are adjacent in the depth direction.

A hob device is also known which has a placement plate embodied as a hob plate and three heating units The hob device additionally has three illumination units, which each have three lighting units which are embodied as individual light sources and accordingly differ from a lighting strip. Lighting units adjacent to one another have a spacing of at least 40 mm.

The object of the invention consists in particular in providing a generic device with improved properties with respect to illumination. The object is achieved according to the invention by the features of claims 1 and 15, while advantageous embodiments and developments of the invention can be taken from the subclaims.

The invention is based on a hob device, in particular on an induction hob device, with at least one placement plate, which is provided for a placement of at least one item of cookware, with at least two heating units for heating the item of cookware and with at least one, in particular dynamic, illumination strip, which in particular has a main function in the form of an illumination and/or in the form of an output of at least one item of information.

It is proposed that the illumination strip has at least one lighting unit and, in at least one operating state, indicates at least one extension of the item of cookware in relation to at least one direction.

By way of the embodiment according to the invention, it is in particular possible to achieve particularly advantageous illumination properties. In particular, a user can rapidly identify an extension of the item of cookware at a glance, whereby the user is able to assess a region still available for further items of cookware in particular in a rapid and/or straightforward manner. In particular, an optimized usability can be provided. It is particularly possible to expand an output region, which is normally restricted to a user interface, whereby information output by means of the illumination strips can be identified by a user in a particularly simple manner, which in particular can be achieved from a size of the output region and/or from a proximity of the output region in relation to the item of cookware.

A “hob device”, in particular an “induction hob device”, is to be understood in particular as meaning at least one part, in particular a subassembly, of a hob, in particular of an induction hob.

A “placement plate” is to be understood in particular as meaning at least one, in particular plate-like, unit which is provided for a placement of at least one item of cookware and/or a setting down of at least one food to be cooked for the purpose of heating. The placement plate could be embodied, for example, as a subregion of at least one worktop, in particular of at least one kitchen worktop, in particular of a cooking system. As an alternative or in addition, the placement plate could be embodied as a hob plate. The placement plate embodied as a hob plate could, in particular, embody at least one part of a hob outer housing and, in particular, could at least largely embody the hob outer housing together with at least one outer housing unit, to which the placement plate embodied as hob plate could be connected in particular in at least one assembled state. The placement plate could be formed, for example, at least largely from glass and/or from glass ceramic and/or from Neolith and/or from Dekton and/or from wood and/or from marble and/or from stone, in particular from natural stone, and/or from laminate and/or from metal and/or from plastic and/or from ceramic. “At least largely” is to be understood in particular as meaning in a proportion, in particular a mass proportion and/or volume proportion, of at least 70%, in particular of at least 80%, advantageously of at least 90% and preferably of at least 95%.

A “heating unit” is to be understood in this context in particular as meaning a unit, which is provided in at least one operating state to feed energy to at least one item of cookware for the purpose of heating the item of cookware. For example, the heating unit could be embodied as a resistance heating unit and in particular be provided to convert energy into heat and to feed this to the item of cookware for the purpose of heating the item of cookware. As an alternative or in addition, the heating unit could be embodied as an induction heating unit and in particular be provided to feed energy to the item of cookware in the form of an electromagnetic alternating field, wherein the energy fed to the item of cookware in particular could be converted into heat in the item of cookware. In at least one operating state, the heating unit feeds energy to the item of cookware in particular, specifically for heating and/or warming the item of cookware in particular. In particular, the hob device has at least three, in particular at least four, advantageously at least six, particularly advantageously eight and preferably a large number of heating units. In particular, the heating units, in particular the hob device, define at least one variable cooking surface region and are arranged in a matrix-like manner in particular.

An “illumination strip” is to be understood in particular as meaning a unit which has an elongated shape and which, in at least one operating state, in particular provides an illumination which is at least substantially continuous. In particular, the illumination strip differs from at least one display. In particular, the illumination strip indicates the extension of the at least two heating units in real space, which differs in particular from a virtual representation of an extension, such as on a display for example. In at least one operating state, the illumination strip is in particular arranged at a distance from at least one user interface, which in particular could have at least one display for outputting at least one operating parameter. In particular, the hob device has at least one user interface, which in particular is provided for inputting and/or outputting at least one operating parameter. The illumination strip in particular has a main function in the form of illuminating and/or outputting at least one item of information and in particular is embodied such that it is distinct from an operating strip of the user interface, the main function of which is in particular operating and/or inputting at least one item of information and/or at least one operating instruction. In particular, the illumination strip is free of sensor elements, which in particular are provided for detecting at least one operating input. By embodying illumination strip and user interface separately, it is advantageously possible to enable a high level of flexibility and/or a high level of design freedom with regard to an arrangement of the illumination strip. In particular, the illumination strip can be arranged in a vicinity of the heating units and/or in a region of increased temperature, specifically in particular while avoiding a risk of an erroneous input by means of the user interface and/or while avoiding a risk of an erroneous detection of an operating instruction.

An “elongated” shape of an object is to be understood in particular as meaning a shape, in which a longitudinal extension of the object is at least three times, in particular at least five times, advantageously at least seven times, particularly advantageously at least ten times and preferably at least fifteen times as large as extensions of the object oriented perpendicular to the longitudinal extension. A “longitudinal extension” of an object is to be understood in particular as meaning an extension of the object along a longitudinal extension direction of the object. A “longitudinal extension direction” of an object is to be understood in particular as meaning a direction which is oriented in parallel with a longest side of a smallest notional geometrical cuboid, which only just fully encloses the object. An “extension” of an object is to be understood in particular as meaning a maximum distance between two points of a perpendicular projection of the object on a plane.

An “at least substantially continuous” illumination is to be understood in particular as meaning a continuous illumination and/or an illumination provided by a large number of lighting units, in which lighting units adjacent to one another, in particular directly, have a spacing of a maximum of 35 mm, in particular of a maximum of 30 mm, advantageously of a maximum of 25 mm, particularly advantageously of a maximum of 20 mm, preferably of a maximum of 15 mm and particularly preferably of a maximum of 10 mm. For example, the illumination strip could have a light source, in particular a single light source, which in at least one operating state in particular provides an at least substantially continuous illumination and in particular could be embodied as a lighting tube, advantageously as a fluorescent tube. As an alternative or in addition, the illumination strip could have at least two, in particular at least three, advantageously at least four and preferably a large number of lighting units, which could be embodied as lighting tubes in each case and which could have a spacing of a maximum of 35 mm, in particular of a maximum of 30 mm, advantageously of a maximum of 25 mm, particularly advantageously of a maximum of 20 mm, preferably of a maximum of 15 mm and particularly preferably of a maximum of 10 mm. As an alternative or in addition, the illumination strips could have a large number of lighting units, which in at least one operating state in particular could provide an at least substantially continuous illumination and in which in particular lighting units adjacent to one another, in particular directly, could have a spacing of a maximum of 35 mm, in particular of a maximum of 30 mm, advantageously of a maximum of 25 mm, particularly advantageously of a maximum of 20 mm, preferably of a maximum of 15 mm and particularly preferably of a maximum of 10 mm.

A “lighting unit” is to be understood in particular as meaning a unit which, in at least one operating state, emits and/or provides electromagnetic radiation, in particular in the form of visible light. In particular, the lighting unit has at least one light source. For example, the lighting unit could have precisely one light source, such as at least one lighting tube for example, in particular at least one fluorescent tube. As an alternative or in addition, the lighting unit could in particular have at least two, advantageously at least three, particularly advantageously at least four and preferably a large number of light sources. For example, the light sources could be embodied as an LED in each case and in particular embody a common assembly unit and/or be arranged within a common lighting unit housing unit.

A “large number” is to be understood in particular as meaning a number of at least five, in particular of at least six, advantageously of at least eight, particularly advantageously of at least ten, preferably of at least twelve and particularly preferably of at least fifteen. In particular, the illumination strip has a large number of lighting units, which in particular are arranged such that they are distributed in a longitudinal extension direction of the illumination strip, in particular in an at least substantially uniform manner. In an installed position, the illumination strip in particular is contact with a rear side of the placement plate, which in particular is embodied as a side of the placement plate remote from a user in an installed position. The placement plate in particular has at least one surface subregion, the illumination strip in particular being provided for the illumination thereof. In particular, in at least one operating state, the illumination strip illuminates the surface subregion and in particular, on the rear side of the placement plate, is in contact with a subregion of a rear side of the placement plate opposite the surface subregion.

A “dynamic” illumination strip is to be understood in particular as meaning an illumination strip which, in at least one operating state, is provided to vary at least one marking property, in particular as a function of an actuation of the illumination strip by at least one control unit, advantageously in a deliberate manner. The deliberate variation of a marking property differs in particular from a variation of the marking property which occurs due to a temperature effect and/or due to deterioration and/or due to wear. A “marking property” is to be understood in particular as meaning a property of an actual marking. In at least one operating mode, the marking property is visible for a user, in particular on an ongoing basis. The marking property could be an illumination property in particular. In particular, the marking could be an illumination. For example, the hob device, in particular in addition to the dynamic illumination strip, could have at least one static lighting strip, which could be provided for marking the at least two heating units. The static illumination strip could be, for example, a marking of the at least two heating units which has been introduced into a surface of the placement plate.

In particular, the hob device has at least one control unit, which in particular is provided at least for controlling and/or for operating the illumination strip. A “control unit” is to be understood in particular as meaning an electronic unit which is preferably at least partially integrated into a control and/or regulating unit of a hob, in particular an induction hob, and which is preferably provided in order to control and/or regulate at least the illumination strip and/or the heating units. Preferably, the control unit comprises a processing unit and in particular, in addition to the processing unit, a memory unit with a control and/or regulation program stored therein, which is provided to be executed by the processing unit. In particular, in the event of an item of cookware being placed, the control unit is provided in order to form at least one heating zone for heating the placed item of cookware from the heating units. The control unit is provided in particular for actuating the illumination strip.

The illumination strip in particular has at least one illumination control unit, which is provided in particular for actuation by the control unit and/or for communication with the control unit. In at least one operating state, the illumination control unit in particular actuates the lighting unit and controls and/or regulates light emitted by the lighting unit in particular. In particular, the illumination control unit and the control unit are arranged and/or embodied separately from one another, in particular spatially, and in particular as stand-alone units. In at least one operating state, the illumination control unit and the control unit communicate with one another in particular. In particular, a user is able to activate and/or deactivate the illumination strip in particular, specifically by means of at least one operating input by means of at least one user interface in particular. For example, in at least one operating state, the illumination control unit could communicate with at least one user interface, in particular the hob device.

For example, the direction could be oriented at least substantially in parallel with the transverse direction and/or at least substantially perpendicular to the depth direction. Advantageously, the direction is oriented at least substantially in parallel with the depth direction and/or at least substantially perpendicular to the transverse direction.

For example, the at least two heating units could be arranged adjacent to one another in at least one transverse direction. A “transverse direction” is to be understood in particular as meaning a direction which is oriented at least substantially in parallel with a front edge of the placement plate. In particular, the at least two heating units are arranged adjacent to one another in at least one depth direction. A “depth direction” is to be understood in particular as meaning a direction which is oriented at least substantially perpendicular to a front edge of the placement plate and which in particular points from a region close to a user to a region remote from a user. The transverse direction and the depth direction are oriented in particular at least substantially perpendicularly to one another and in particular at least substantially in parallel with a main extension plane of the placement plate.

A “main extension plane” of an object is to be understood in particular as meaning a plane which is in parallel with a largest side area of a smallest notional geometrical cuboid, which only just fully encloses the object, and in particular runs through the center point of the cuboid. “Substantially in parallel” is to be understood here in particular as meaning an orientation of a direction relative to a reference direction, in particular in a plane, wherein compared to the reference direction the direction has a deviation of in particular less than 8°, advantageously less than 5° and particularly advantageously less than 2°. The phrase “substantially perpendicular” is to be understood here in particular as meaning an orientation of a direction relative to a reference direction, wherein the direction and the reference direction, in particular when viewed in a plane, enclose an angle of 90° and the angle has a maximum deviation of in particular less than 8°, advantageously less than 5° and particularly advantageously less than 2°.

“Provided” is to be understood in particular as meaning especially configured and/or equipped. The fact that an object is provided for a particular function is to be understood in particular as meaning that the object fulfills and/or carries out this particular function in at least one application and/or operating state.

In a further aspect of the invention, which can be considered on its own or together with other aspects of the invention, it is proposed that the illumination strip has a longitudinal extension of at least 200 mm, in particular of at least 250 mm, advantageously of at least 300 mm, particularly advantageously of at least 350 mm, preferably of at least 400 mm and particularly preferably of at least 450 mm. This means that it is in particular possible to illuminate a large region, such as a variable cooking surface region in particular, by means of the illumination strip, which in particular makes it possible to dispense with further illumination strips and/or to achieve a low amount of stockkeeping.

In a further aspect of the invention, which can be considered on its own or together with other aspects of the invention, it is proposed that the illumination strip has at least one lighting unit and, in at least one operating state, in relation to at least one direction, indicates at least one operating parameter which varies in the direction. For example, the direction could be oriented at least substantially in parallel with the transverse direction and/or at least substantially perpendicular to the depth direction. Advantageously, the direction is oriented at least substantially in parallel with the depth direction and/or at least substantially perpendicular to the transverse direction. The operating parameter, for example, could be at least one temperature, to which an item of cookware is to be heated in particular, and/or at least one heating output, by means of which an item of cookware is heated in particular and/or which a corresponding heating unit of the at least two heating units provides in at least one operating state in particular. The illumination strip could indicate the operating parameter which varies in the direction in particular by means of at least one change in an intensity and/or a color and/or a brightness and/or a saturation. This in particular makes it possible to achieve a high level of operating convenience, as a user is able to identify the operating parameter in a simple and rapid manner in particular.

It is additionally proposed that the illumination strip extends at least substantially over an entire depth extension of the placement plate. The expression that the illumination strip extends “at least substantially” over an entire depth extension of the placement plate is to be understood in particular as meaning that the illumination strip extends over a portion of at least 60%, in particular of at least 70%, advantageously of at least 80%, particularly advantageously of at least 90% and preferably of at least 95% of a depth extension of the placement plate. A “depth extension” of an object is to be understood in particular as meaning an extension of the object in the depth direction. This means that it is in particular possible to illuminate at least substantially the entire depth extension of the placement plate by means of a single illumination strip, which in particular makes it possible to dispense with further illumination strips and/or to achieve a low amount of stockkeeping.

In the operating state, the illumination strip could for example exclusively indicate the extension of the item of cookware. Preferably, in the operating state, the illumination strip indicates at least one position of the item of cookware in relation to the direction, namely in particular in relation to at least one reference point, for example such as at least one user interface and/or advantageously at least one front edge of the placement plate. A “front edge” of a placement plate is to be understood in particular as meaning an edge of the placement plate close to a user in the operating state. As a result, in particular in addition to the extension of the item of cookware, it is possible in particular for at least one additional item of information to be output to a user, whereby it is possible in particular for a high level of operating convenience to be achieved.

It is further proposed that the lighting unit is embodied as a colored lighting unit and is provided for emitting light with at least two, in particular with at least three, advantageously with at least four, particularly advantageously at least eight, preferably with at least twelve and particularly preferably with a large number of colors. The lighting unit may in particular have at least two, advantageously at least three, particularly advantageously at least four and preferably a large number of light sources, which in particular may be provided in each case for emitting light in a determined color, for which reason the lighting unit, in particular on the basis of a sum of various light sources, could be provided in particular for emitting light in various colors. As an alternative or in addition, the lighting unit could have at least one light source, which in particular could be provided for emitting light in various colors. The lighting unit is in particular provided for emitting light in at least 50, in particular with at least 100, advantageously with at least 150, particularly advantageously with at least 200, preferably with at least 225 and particularly preferably with at least 250 colors. This means that it is possible in particular to enable a high level of flexibility and/or a high level of design freedom. In particular, it is possible for information, in particular regarding at least one operating parameter and/or at least one property of the item of cookware and/or at least one direction of movement of the item of cookware, to be indicated to a user in a simple and/or intuitive manner. An “operating parameter” is to be understood in particular as meaning a parameter which characterizes an operation, for example at least one heating state and/or a progression of at least one heating state and/or at least one heating state which is predefined for a given heating zone and/or a position of at least one item of cookware. A “heating state” is to be understood in particular as meaning a heating output, in particular current and/or prevailing, and/or a temperature, in particular current and/or prevailing, and/or a residual heat, in particular current and/or prevailing. A “property of the item of cookware” is to be understood in particular as meaning an extension of the item of cookware and/or a material of the item of cookware and/or an area extension of the item of cookware, in particular with a perpendicular view of a main extension plane of the placement plate.

For example, the lighting unit could have precisely one light source, such as at least one lighting tube for example, in particular at least one fluorescent tube. The illumination strip preferably has at least one further lighting unit and in particular at least two, advantageously at least three, particularly advantageously at least four and preferably a large number of lighting units, which is/are able to be actuated independently of the lighting unit, in particular are able to be activated and/or deactivated. In particular, the lighting unit is able to be actuated independently of the further lighting unit and thus in particular while avoiding an influencing of an activity state of the further lighting unit. In particular, it is possible to set at least one lighting property of the lighting unit and of the further lighting unit independently of one another. A “lighting property” of a lighting unit is to be understood in particular as meaning an intensity and/or a brightness and/or a color of the lighting unit and/or of a light emitted by the lighting unit. This means that it is possible in particular to enable a particularly high level of flexibility and/or a particularly high level of design freedom.

It is furthermore proposed that the illumination strip, in the operating state, indicates at least one heating state of the item of cookware, whereby a particularly high level of operating convenience can be achieved in particular. In particular, a user can be warned of at least one warm and/or hot region, whereby a high level of safety and/or a low level of risk of injury to a user can be enabled in particular.

It is further proposed that the illumination strip, in the operating state, indicates at least one direction of movement, in which the item of cookware can be moved. In particular, the direction of movement, starting from a first placement position of the item of cookware, on which the item of cookware is currently placed in particular, points in the direction of at least one further region, in particular at least one cooking surface region at least partially defined by the at least two heating units. A “placement position” of the item of cookware is to be understood in particular as meaning a position of the item of cookware above the placement plate, at which the item of cookware is positioned and/or arranged and/or placed for the purpose of heating the item of cookware. This means in particular that it is possible to indicate at least one possibility, for example for optimizing a placement position of the item of cookware and/or for varying a heating output, by means of which the item of cookware can be heated in particular.

For example, the illumination strip could indicate the direction of movement, in which the item of cookware can be moved in particular, in the operating state by means of at least one color curve and/or by means of at least one brightness curve. In the operating state, the illumination strip preferably indicates the direction of movement by means of at least one intensity curve, specifically in particular by means of an intensity gradient. In particular, the illumination strip could indicate the direction of movement, in which the item of cookware can be moved in particular, in the operating state by means of at least one temporal intensity curve and/or color curve and/or brightness curve. As an alternative or in addition, the illumination strip could indicate the direction of movement, in which the item of cookware can be moved in particular, in the operating state in particular by means of at least one spatial intensity curve and/or color curve and/or brightness curve. This means that the direction of movement can be indicated for a user in a rapidly and/or particularly easily identifiable manner in particular, whereby a straightforward and/or convenient usability can be provided in particular.

It is furthermore proposed that the illumination strip, in the operating state, indicates at least one movement of the item of cookware from a first placement position to a second placement position. This means that it is possible in particular to achieve a particularly high level of transparency and/or a particularly convenient usability. In particular, a user can be offered the possibility, while moving the item of cookware, of changing at least one operating parameter and/or transferring at least one operating parameter from the first placement position to the second placement position.

It is further proposed that, in the operating state, the illumination strip indicates the movement of the item of cookware by deactivating the illumination of the first placement position and activating an illumination of the second placement position. For example, in the operating state, the illumination strip could vary at least one illumination property, in particular at least two, advantageously at least four, particularly advantageously a large number of and preferably all illumination properties of the illumination of the first placement position when activating the illumination of the second placement position. Advantageously, in the operating state, the illumination strip transfers at least one illumination property, in particular at least two, advantageously at least four, particularly advantageously a large number of and preferably all illumination properties from the illumination of the first placement position to the illumination of the second placement position. This means that the movement of the item of cookware in particular can be indicated in a particularly intuitive and/or easy-to-understand manner, whereby a simple usability can be achieved in particular.

For example, in the operating state, the illumination strip could exclusively deactivate the illumination of the first placement position and activate the illumination of the second placement position. Preferably, in the operating state, the illumination strip indicates at least one operating prompt, before activating the illumination of the second placement position, by at least a changing of at least one illumination property. An “illumination property” is to be understood in particular as meaning a property and/or a characteristic of an illumination provided by the illumination strip, such as a brightness and/or a color and/or an intensity and/or an activation type of the illumination provided by the illumination strip for example. The activation type of the illumination could be, for example, an ongoing illumination and/or a frequented illumination and/or a flashing illumination and/or an illumination in the form of a pattern. The operating prompt is, in particular, a confirmation of the movement of the item of cookware from the first placement position to the second placement position, which the user can perform by way of at least one operating input in particular. An “operating input” is to be understood in particular as meaning an optical and/or acoustic and/or haptic input by means of at least one operating interface, in particular by a user. In particular, this makes it possible in particular to achieved a high level of safety and/or to avoid an accidental activation of the illumination and/or of at least one heating unit at the second placement position. In particular, a low susceptibility to error can be enabled.

By way of the illumination strip, it is possible in particular for various optical information in relation to an operating state and/or to a heating state and/or to a usability to be indicated to a user, specifically in particular as a function of a prevailing state and/or an action taking place at present. In particular, an advantageous usability can be achieved by the illumination strip, specifically in particular by indicating at least one item of information in relation to an operating state and/or in relation to a heating state and/or in relation to a usability. In particular, due to the independence of the lighting units and/or due to the various colors which the lighting unit is able to emit in particular, it is possible in particular for at least one item of information to be output to a user in a flexible manner. The information may for example involve, in particular in addition to the extension of the item of cookware, a size of the item of cookware and/or a placement position of the item of cookware and/or a position of the item of cookware and/or a heating state and/or a residual heat and/or a heating output and/or a possible direction of movement and/or heating zones with various predefined heating outputs and/or a heating output curve.

A particularly optimized illumination can be achieved in particular by a hob, in particular by an induction hob, with at least one hob device.

An advantageous illumination can be achieved in particular by a cooking system with the hob and with the item of cookware. A “cooking system” is to be understood in particular as meaning a system which has at least one cooking appliance, which is provided for cooking foodstuffs, such as an oven and/or a hob and/or a microwave for example, and which additionally in particular could have at least one further structural unit, which is embodied as different from a cooking appliance, such as in particular a cleaning appliance and/or a refrigeration appliance and/or a mobile device and/or at least one contact module. In particular, the cooking system is provided to have at least one structural unit, which is provided for an arrangement in a kitchen. The cooking system could have at least one accessory unit for the cooking appliance, for example, such as a sensor unit for externally measuring a temperature of an item of cookware and/or a food to be cooked, for example.

An illumination can in particular be further optimized by a method for operating a hob device, with at least one placement plate, which is provided for a placement of at least one item of cookware, with at least two heating units for a heating of the item of cookware and with at least one, in particular dynamic, illumination strip, wherein, in at least one operating state, at least one extension of the item of cookware in relation to at least one direction is indicated.

In this context, the hob device should not be restricted to the use and embodiment described above. In particular, the hob device may have a number of individual elements, parts and units deviating from a number mentioned herein for fulfilling a mode of operation described herein.

Further advantages result from the following description of the drawing. The drawing shows exemplary embodiments of the invention. The drawing, the description and the claims contain numerous features in combination. The person skilled in the art will expediently also consider the features individually and combine them to form useful further combinations.

In the drawing:

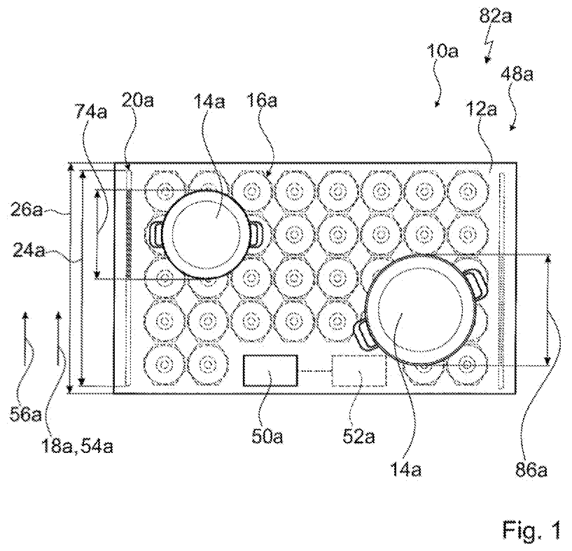

FIG. 1 shows a cooking system with a hob, which has a hob device, and with two items of cookware in an operating state in a schematic plan view,

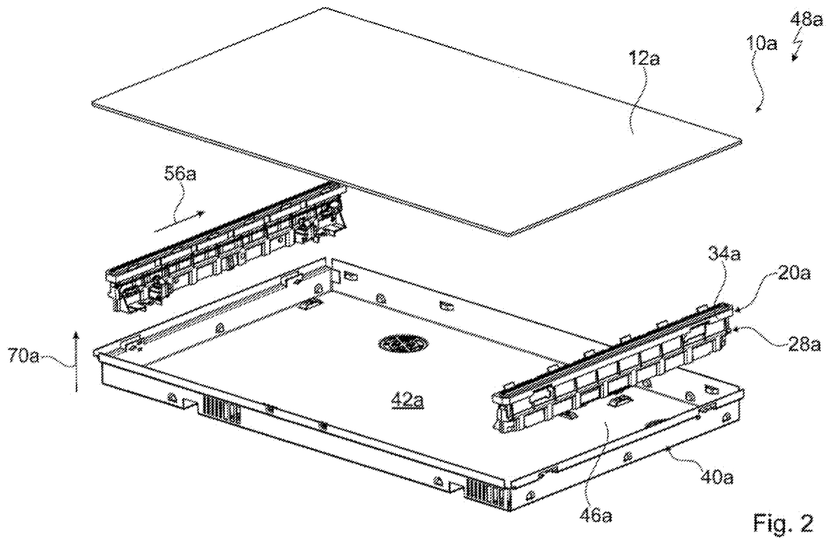

FIG. 2 shows a hob housing unit, a placement plate and two illumination strips of the hob device in a schematic exploded representation,

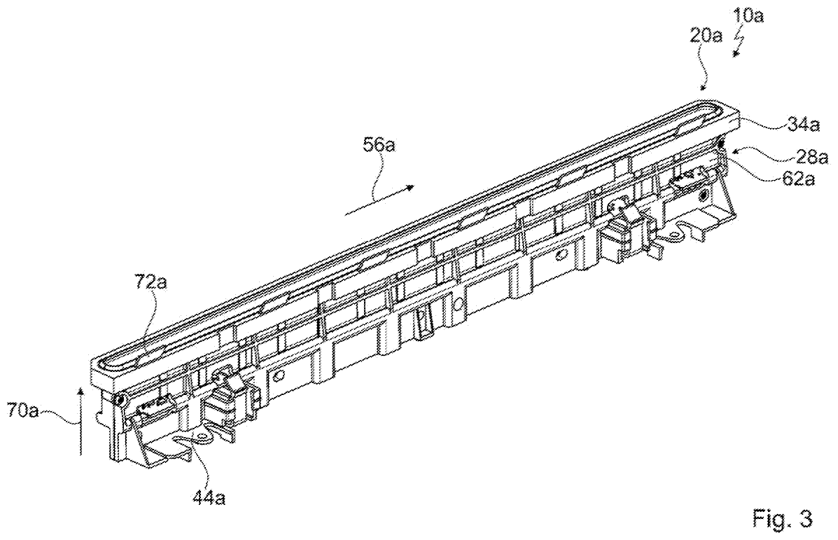

FIG. 3 shows one of the illumination strips in a perspective representation,

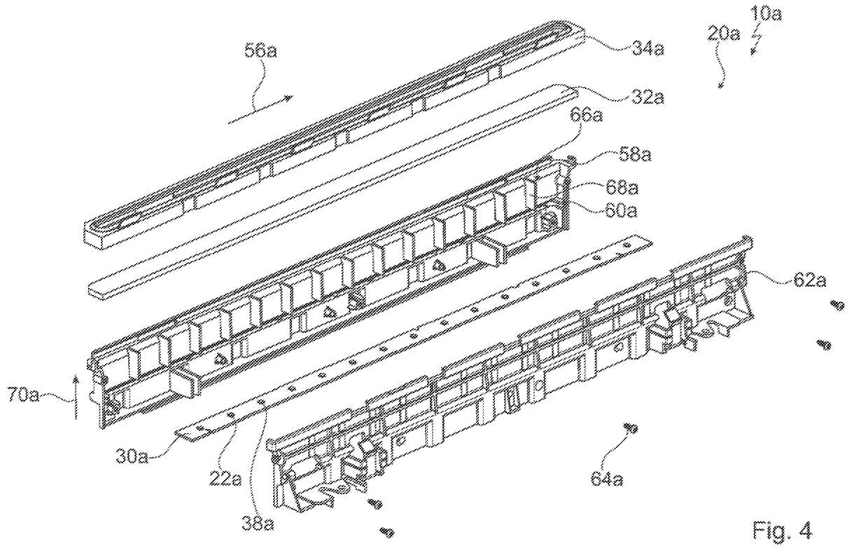

FIG. 4 shows the illumination strip from FIG. 3 in a perspective exploded representation,

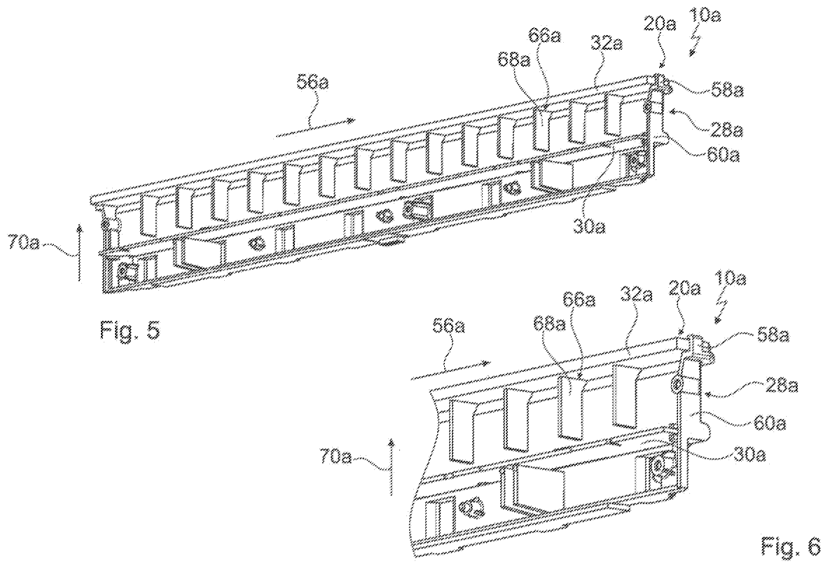

FIG. 5 shows a housing subelement of a housing unit, a circuit board and a diffusion unit of the illustration strip from FIG. 3 in a perspective representation,

FIG. 6 shows an enlarged portion of FIG. 5,

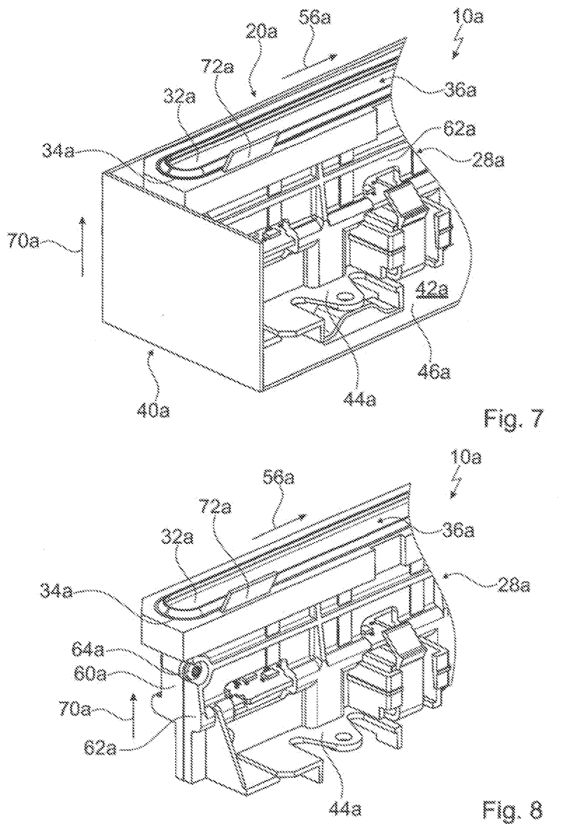

FIG. 7 shows a portion of the hob housing unit and the illumination strip from FIG. 3 in a perspective representation,

FIG. 8 shows a portion of the illumination strip from FIG. 3 in a perspective representation,

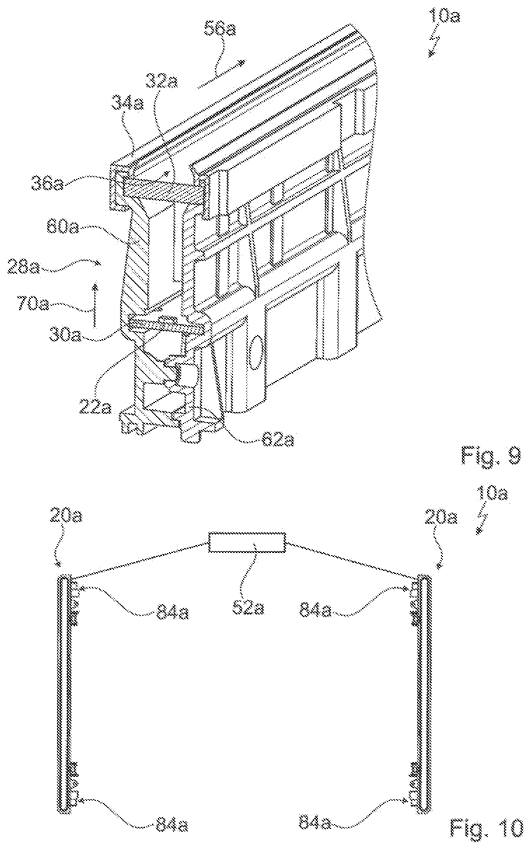

FIG. 9 shows the illumination strip from FIG. 3 in a partial sectional representation,

FIG. 10 shows the illumination strip from FIG. 2 and a control unit of the hob device in a schematic representation,

FIG. 11 shows the cooking system with the hob and with an item of cookware in an operating state in a schematic plan view,

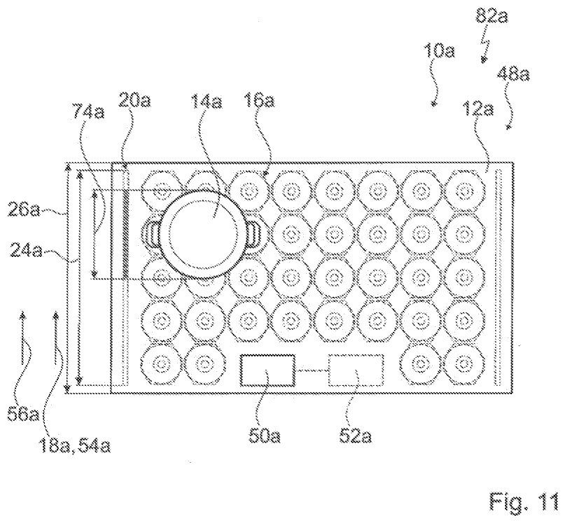

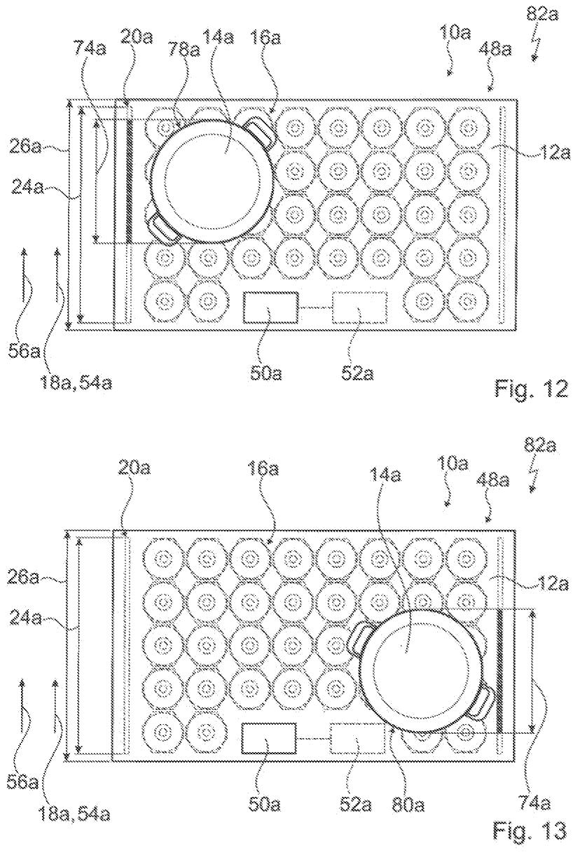

FIG. 12 shows the cooking system with the hob and with an item of cookware in an operating state in a schematic plan view,

FIG. 13 shows the cooking system with the hob and with an item of cookware in an operating state in a schematic plan view,

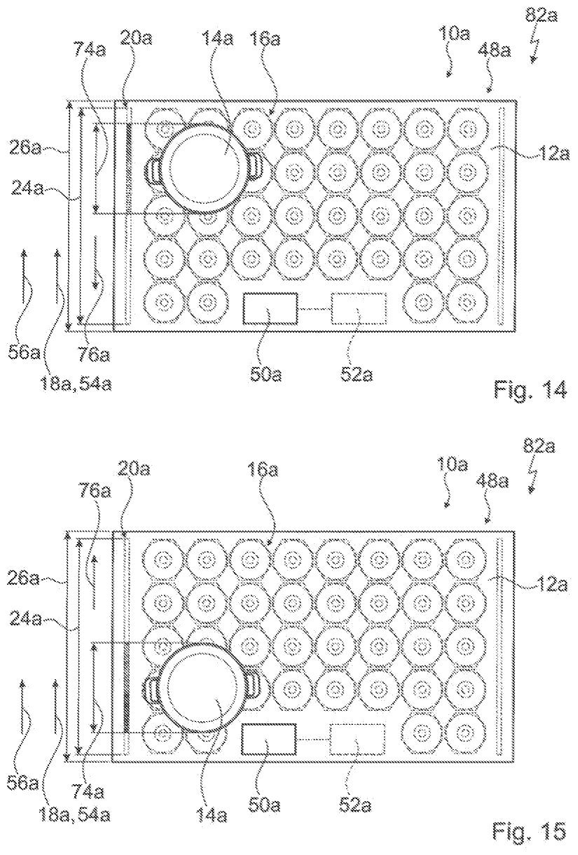

FIG. 14 shows the cooking system with the hob and with an item of cookware in an operating state in a schematic plan view,

FIG. 15 shows the cooking system with the hob and with an item of cookware in an operating state in a schematic plan view,

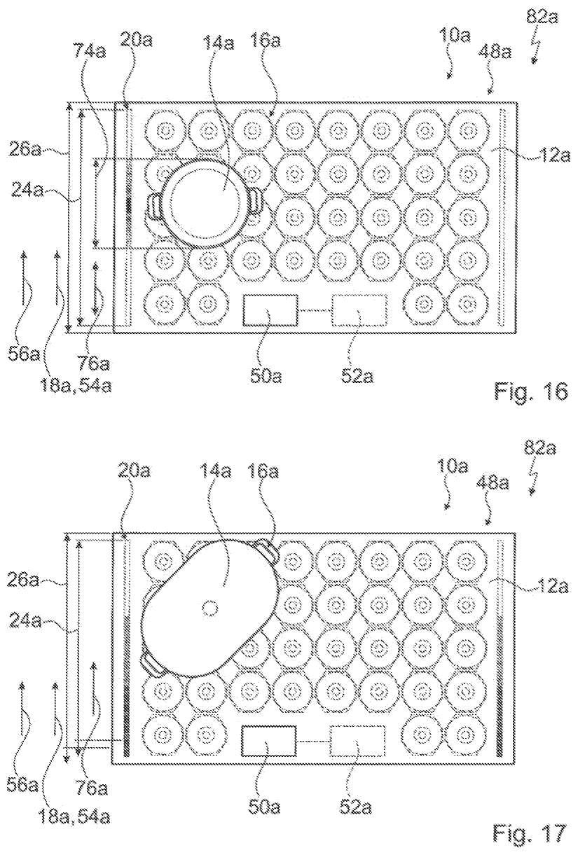

FIG. 16 shows the cooking system with the hob and with an item of cookware in an operating state in a schematic plan view,

FIG. 17 shows the cooking system with the hob and with an item of cookware in an operating state in a schematic plan view,

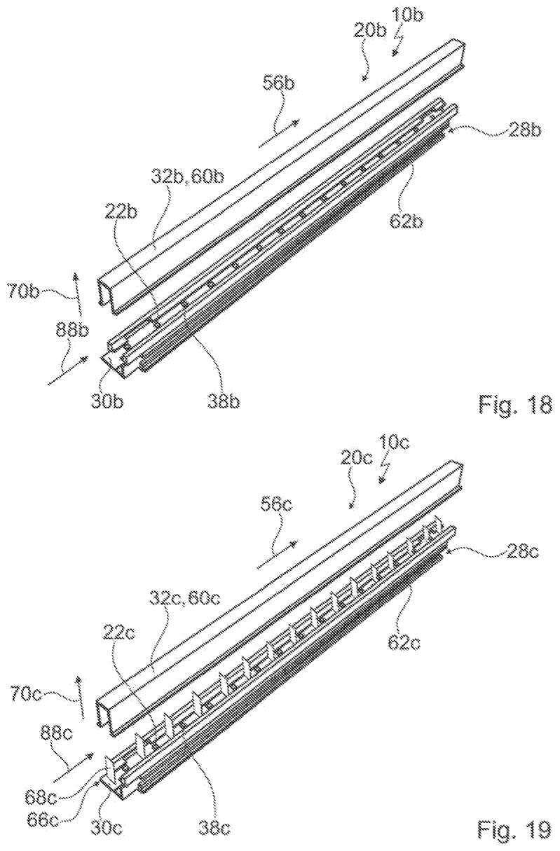

FIG. 18 shows an illumination strip of an alternative hob device in a perspective representation,

FIG. 19 shows an illumination strip of an alternative hob device in a perspective representation,

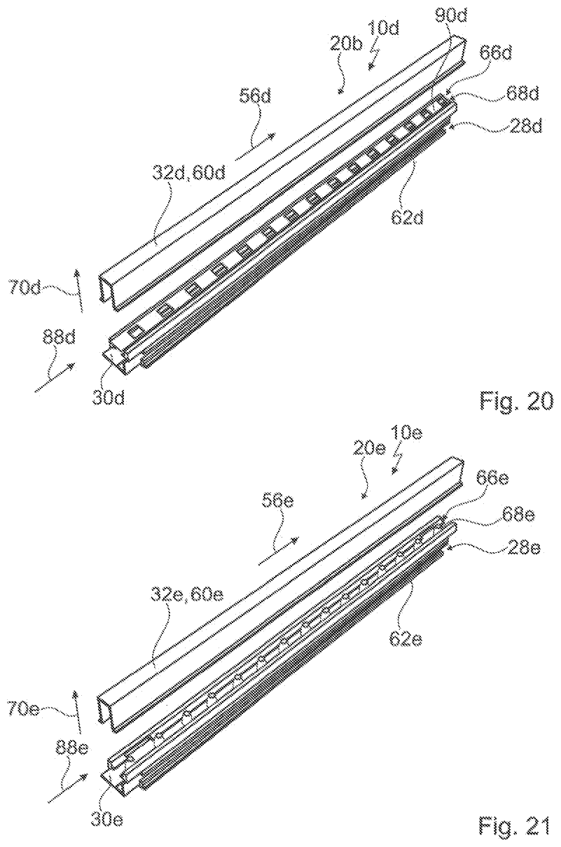

FIG. 20 shows an illumination strip of an alternative hob device in a perspective representation and

FIG. 21 shows an illumination strip of an alternative hob device in a perspective representation.

FIG. 1 shows a cooking system 82a with a hob 48a and with two items of cookware 14a. The hob 48a is embodied as an induction hob. The hob 48a has a hob device 10a, which is embodied as an induction hob device.

The hob device 10a has a placement plate 12a. In the present exemplary embodiment, the placement plate 12a is embodied as a hob plate. In an assembled state, the placement plate 12a embodies part of a hob outer housing, specifically in particular of a hob outer housing of the hob 48a in particular. The placement plate 12a is provided for a placement of items of cookware 14a (see FIGS. 1 and 11 to 17).

The hob device 10a has a large number of heating units 16 for heating items of cookware 14a. Only one of the objects present repeatedly in the figures is provided with a reference character in each case. In the present exemplary embodiment, the hob device 10a has thirty six heating units 16a. The heating units 16a are arranged below the placement plate 12a in an installed position. The heating units 16a are provided to heat items of cookware 14a placed on the placement plate 12a above the heating units 16a. In the present exemplary embodiment, the heating units 16a are embodied as induction heating units.

The hob device 10a has a user interface 50a for inputting and/or selecting operating parameters, for example a heating output and/or a heating output density and/or a heating zone. The user interface 50a is provided for outputting a value of an operating parameter to a user.

The hob device 10a has a control unit 52a. The control unit 52a is provided to carry out actions and/or to vary settings as a function of operating parameters input by means of the user interface 50a. The control unit 52a regulates an energy supply to the heating units 16a in a heating operating state.

The hob device 10a has a hob outer housing unit 40a (see FIGS. 2 and 7). In an operating state, the hob outer housing unit 40a embodies part of the hob outer housing. The hob outer housing unit 40a embodies the hob outer housing together with the placement plate 12a in an operating state. The hob outer housing unit 40a partially defines a storage space 42a. In an operating state, the hob outer housing unit 40a defines the storage space 42a together with the placement plate 12a.

In the present exemplary embodiment, the hob device 10a has two illumination strips 20a (see FIGS. 1 to 9). Just one of the illumination strips 20a is described in the following. The illumination strip 20a has a lighting unit 22a (see FIG. 4). In addition to the lighting unit 22a, the illumination strip 20a has a large number of further lighting units 38a. Just one of the further lighting units 38a is described in the following.

Each lighting unit 22a, 38a is able to be actuated independently of other lighting units 22a, 38a. The further lighting unit 38a is able to be actuated independently of the lighting unit 22a. In the following, in place of all lighting units 22a, 38a, only the lighting unit 22a is described. An analogous description could also be performed for the further lighting unit 38a.

The lighting unit 22a is embodied as a colored lighting unit 22a. In an operating state, the lighting unit 22a emits light with different colors. The lighting unit 22a is provided for emitting light with at least two colors. In the present exemplary embodiment, the lighting unit 22a is provided for emitting light with 256 colors.

In an operating state, the illumination strip 20a is assigned to a large number of heating units 16a. In the present exemplary embodiment, for marking half of all the heating units 16a, the illumination strip 20a is assigned to said half of all the heating units 16a. For marking eighteen heating units 16a, the illumination strip 20a is assigned to the eighteen heating units 16a.

In the present exemplary embodiment, the illumination strip 20a has a longitudinal extension 24a of substantially 445 mm. In an operating state, the illumination strip 20a is arranged in parallel with a depth direction 54a. The illumination strip 20a has a longitudinal extension direction 56a, which is oriented in parallel with the depth direction 54a in an operating state.

In the present exemplary embodiment, the illumination strip 20a extends substantially over an entire depth extension 26a of the placement plate 12a. The placement plate 12a has a depth extension 26a of substantially 480 mm. The illumination strip 20a extends over substantially 93% of an entire depth extension 26a of the placement plate 12a.

The illumination strip 20a has a housing unit 28a (see FIGS. 2 to 9). In an operating state, the lighting unit 22a is largely arranged within the housing unit 28a. In an operating state, the lighting unit 22a is largely surrounded by the housing unit 28a.

The illumination strip 20a has a circuit board 30a (see FIGS. 4 to 6 and 9). In an operating state, the circuit board 30a is largely arranged within the housing unit 28a. In an operating state, the lighting unit 22a is arranged on the circuit board 30a. In an operating state, the lighting unit 22a is in electrical contact with the circuit board 30a.

The illumination strip 20a has a diffusion unit 32a (see FIGS. 2 to 9). The diffusion unit 32a is provided for scattering light emitted by the lighting unit 22a. In an operating state, the diffusion unit 32a scatters light emitted by the lighting unit 22a. In the present exemplary embodiment, the diffusion unit 32a has a cuboid shape in a cross-sectional plane, which in particular is oriented perpendicular to a longitudinal extension direction of the diffusion unit 32a.

In an operating state, the diffusion unit 32a is arranged on the housing unit 28a. In the present exemplary embodiment, the diffusion unit 32a is largely arranged within the housing unit 28a in an operating state.

The illumination strip 20a has at least one diffusion unit retaining element 58a. In the present exemplary embodiment, the illumination strip 20a has two diffusion unit retaining elements 58a, which in particular are arranged in mutually opposing end regions of the illumination strip 20a in relation to the longitudinal extension direction 56a of the illumination strip 20a. Just one of the diffusion unit retaining elements 58a is described in the following.

The diffusion unit retaining element 58a is arranged on the housing unit 28a. The diffusion retaining element 58a is connected to the housing unit 28a in one piece. In the present exemplary embodiment, the housing unit 28a is embodied in a two-piece manner. The housing unit 28a has a first housing subelement 60a and a second housing subelement 62a. In an operating state, the first housing subelement 60a and the second housing subelement 62a are fastened to one another.

The illumination strip 20a has at least one fastening means 64a. In the present exemplary embodiment, the illumination strip 20a has five fastening means 64a.

Just one of the fastening means 64a is described in the following. In an operating state, the fastening means 64a fastens the first housing subelement 60a and the second housing subelement 62 to one another. In the present exemplary embodiment, the fastening means 64a is embodied as a screw.

The illumination strip 20a has a seal unit 34a (see FIGS. 2, 3 and 6 to 9). In an operating state, the seal unit 34a largely seals off a lighting region 36a between the housing unit 28a and the placement plate 12a. The seal unit 34a is provided for sealing off the lighting region 36a between the housing unit 28a and the placement plate 12a.

In an operating state, the housing unit 28a is partially arranged within the seal unit 34a. In an operating state, the seal unit 34a encloses a housing section of the housing unit 28a, in sections (see FIG. 9 in particular). The housing section of the housing unit 28a is arranged on a region of the housing unit 28a close to the placement plate 12a in an operating state.

The illumination strip 20a has a light separating unit 66a (see FIGS. 4 to 6). In an operating state, the light separating unit 66a is arranged on the housing unit 28a and in particular is connected to the housing unit 28a in one piece.

The light separating unit 66a has at least one light separating element 68a. The light separating unit 66a has a large number of light separating elements 68a in the present exemplary embodiment. Just one of the light separating elements 68a is described in the following. The light separating element 68a is embodied in a web-like manner. In an operating state, the light separating element 68a extends substantially in parallel with a vertical direction 70a.

In an operating state, the light separating unit 66a partially separates light portions from the lighting unit 22a and light portions from the further lighting unit 38a, in particular by means of the light separating element 68a. The light separating unit 66a is provided for at least partially separating light portions from the lighting unit 22a and light portions from the further lighting unit 38a, in particular by means of the light separating element 68a.

In the present exemplary embodiment, the illumination strip 20a has a large number of keep-clear elements 72a (see FIGS. 2 to 4 and 7 to 9). Just one of the keep-clear elements 72a is described in the following. During assembly, the keep-clear element 72a is provided for preventing a penetration of at least one object into the lighting region 36a partially defined by the illumination strip 20a.

In the present exemplary embodiment, the keep-clear element 72a is embodied in a tab-shaped manner. In an operating state, the keep-clear element 72a is arranged on the seal unit 34a and in particular is connected to the seal unit 34a in one piece.

In an operating state, the illumination strip 20a is largely arranged within the hob outer housing unit 40a. In an operating state, the illumination strip 20a is largely arranged within the storage space 42a.

In an operating state, the illumination strip 20a is fastened to a hob housing base 46a of the hob outer housing unit 40a (see FIGS. 2 and 7). The illumination strip 20a has two fastening elements 44a in the present exemplary embodiment. Just one of the fastening elements 44a is described in the following. In an operating state, the fastening element 44a fastens the housing unit 28a of the illumination strip 20a to the hob housing base 46a of the hob outer housing unit 40a. The fastening element 44a is provided for fastening the housing unit 28a to the hob housing base 46a of the hob outer housing unit 40a.

The illumination strip 20a is provided for actuation by the control unit 52a (see FIG. 10). The illumination strip 20a has at least one actuation connection 84a. In the present exemplary embodiment, the illumination strip 20a has two actuation connections 84a. In relation to the longitudinal extension direction 56a of the illumination strip 20a, the actuation connections 84a are arranged in mutually opposing end regions of the illumination strip 20a. This makes it possible for the illumination strip 20a to be assembled flexibly on any side of the hob, these in particular being arranged in mutually opposing end regions of the hob outer housing unit 40a in relation to a transverse direction.

In a method for operating the hob device 10a, half of all the heating units 16a are marked by means of a single illumination strip 20a in an operating state (see FIGS. 1 and 11 to 17).

For example, in an operating state, two items of cookware 14a are placed on the placement plate 12a (see FIG. 1). In an operating state, the illumination strip 20a indicates an extension 74a, 86a of each item of cookware 14a of the items of cookware 14a in relation to a direction 18a. In an operating state, the illumination strip 20a indicates an extension 74a of a first item of cookware 14a of the items of cookware 14a in the direction 18a. In an operating state, the illumination strip 20a indicates an extension 86a of a second item of cookware 14a of the items of cookware 14a in the direction 18a. The extension 74a of the first item of cookware 14a in the direction 18a is smaller than the extension 86a of the second item of cookware 14a in the direction 18a.

In addition to the extension 74a, 86a of the item of cookware 14a in relation to the direction 18a, in an operating state the illumination strip 20a indicates a position of each item of cookware 14a of the items of cookware 14a in relation to the direction 18a.

In an operating state, the illumination strip 20a indicates a heating state of the item of cookware 14a (see FIG. 1). In an operating state, the illumination strip 20a indicates the heating state of the item of cookware 14a, in particular embodied as a heating output, with varying colors. For example, the illumination strip 20a indicates a high heating state, in particular embodied as heating output, with a different color than a low heating state, in particular embodied as heating output. The different colors are characterized in FIG. 1 by different densities of hatch markings, wherein a dense hatch marking is assigned a high heating output and a broad hatch marking is assigned a low heating output.

For example, starting from the configuration from FIG. 1, an item of cookware 14a of the items of cookware 14a is removed from the placement plate 12a (see FIG. 11). In an operating state, the illumination strip 20a indicates a heating state embodied as residual heat. The illumination strip 20a indicates the heating state, in particular embodied as residual heat, even after the item of cookware 14a has been removed from the placement plate 12a, specifically in particular until a residual heat falls below a threshold value. For example, the illumination strip 20a indicates a high heating state, in particular embodied as residual heat, with a different color than a low heating state, in particular embodied as residual heat.

In an operating state, the illumination strip 20a indicates a movement of the item of cookware 14a from a first placement position 78a to a second placement position 80a (see FIGS. 12 and 13). In an operating state, the illumination strip 20a indicates the movement of the item of cookware 14a by deactivating the illumination of the first placement position 78a and activating an illumination of the second placement position 80a. Before activating the illumination of the second placement position 80a, in an operating state, the illumination strip 20a indicates an operating prompt by changing an illumination property. In an operating state, before activating the illumination of the second placement position 80a, the illumination strip 20 indicates an animation, in order to transmit the operating prompt to the user in particular. In the present exemplary embodiment, the operating prompt is a prompt for confirming a movement of the item of cookware 14a from the first placement position 78a to a second placement position 80a.

In an operating state, the illumination strip 20a indicates a direction of movement 76a, in which the item of cookware 14a can be moved (see FIGS. 14 to 16). In an operating state, the illumination strip 20a indicates the direction of movement 76a by means of an intensity curve, specifically in particular by means of an intensity gradient. If, for example, an item of cookware 14a is placed in a rear region of the placement plate 12a, then the illumination strip 20a indicates the direction of movement 76a in the direction of a front region of the placement plate 12a (see FIG. 14). If, for example, an item of cookware 14a is placed in a front region of the placement plate 12a, then the illumination strip 20a indicates the direction of movement 76a in the direction of a rear region of the placement plate 12a (see FIG. 15). In the case of an item of cookware 14a, which is arranged in a central region of the placement plate 12a, the illumination strip 20a indicates the direction of movement 76a in the direction of a rear region of the placement plate 12a and in the direction of a front region of the placement plate 12a (see FIG. 16).

In a method for operating the hob device 10a, in an operating state, an extension 74a of the item of cookware 14a in relation to the direction 18a is indicated by means of the illumination strip 20a.

In an operating state, the illumination strip 20a indicates an in particular predefined heating output, which varies in the direction 18a, in particular in addition or as an alternative to the extension 74a of the item of cookware 14a, in relation to the direction 18a (see FIG. 17). If, for example, an in particular predefined heating output in a front region of the placement plate 12a is greater than in a rear region of the placement plate 12a and the heating output decreases, in particular monotonically, from the front region in the direction of the rear region, then the illumination strip 20a indicates, in relation to the direction 18a, the in particular predefined heating output, which varies in the direction 18a, by means of an intensity curve and/or by means of a color curve and/or by means of a brightness curve.

FIGS. 18 and 21 show further exemplary embodiments of the invention. The following descriptions are essentially restricted to the differences between the exemplary embodiments, wherein with regard to components, features and functions which remain the same, reference can be made to the description of the exemplary embodiment in FIGS. 1 to 17. In order to differentiate the exemplary embodiments, the letter a in the reference characters of the exemplary embodiment in FIGS. 1 to 17 is replaced by the letters b to e in the reference characters of the exemplary embodiment of FIGS. 18 to 21. With regard to parts that remain the same, in particular with regard to parts with the same reference characters, in principle, reference can also be made to the drawings and/or the description of the exemplary embodiment of FIGS. 1 to 17.

FIG. 18 shows an illumination strip 20b of an alternative hob device 10b. The illumination strip 20b has a diffusion unit 32b, which is provided for scattering light emitted by lighting units 22b of the illumination strip 20b. In the present exemplary embodiment, the diffusion unit 32b is U-shaped in a cross-sectional plane, which in particular is oriented perpendicular to a longitudinal extension direction of the diffusion unit 32b.

The illumination strip 20b has a housing unit 28b. In the present exemplary embodiment, the housing unit 28b is embodied in a two-piece manner. The housing unit 28b has a first housing subelement 60b and a second housing subelement 62b. In an operating state, the first housing subelement 60b and the second housing subelement 62b are fastened to one another. In an operating state, the first housing subelement 60a is arranged on a side of the illumination strip 20b close to a placement plate 12b. In an operating state, the second housing subelement 62a is arranged on a side of the illumination strip 20b remote from the placement plate 12b.

The diffusion unit 32b is embodied in one piece with the illumination strip 20b, specifically in particular with the first housing subelement 60b of the illumination strip 20b. In the present exemplary embodiment, the illumination strip 20b largely consists of plastic. The illumination strip 20b is free of a light separating unit.

In an operating state, a circuit board 30b of the illumination strip 20b is arranged within the housing unit 28b, specifically in particular within the second housing subelement 62b of the illumination strip 20b. The illumination strip 20b has a receiving groove (not shown), which in particular is arranged on the second housing subelement 62b. The receiving groove is provided for retaining and/or storing the circuit board 30b. During assembly, the circuit board 30b is introduced and/or inserted into the receiving groove in an insertion direction 88b. The insertion direction 88b is substantially oriented in parallel with a longitudinal extension direction 56b of the illumination strip 20b. In an operating state, the circuit board 30b is retained and/or stored in the receiving groove.

FIG. 19 shows an illumination strip 20c of an alternative hob device 10c. The illumination strip 20c has a light separating unit 66c. In an operating state, the light separating unit 66c is arranged within a housing unit 28c of the illumination strip 20c. In an operating state, the light separating unit 66c is arranged on a circuit board 30c of the illumination strip 20c. The light separating unit 66c and the housing unit 28c are embodied as separate objects.

The light separating unit 66c has a large number of light separating elements 68c. One light separating element 68c is arranged between two lighting units 22c of the illumination strip 20c arranged adjacent to one another, in relation to a longitudinal extension direction 56c of the illumination strip 20c, in each case. The light separating elements 68c are embodied in a web-like and/or small plate-like manner. In an operating state, the light separating unit 66c, in particular the light separating elements 68c of the light separating unit 66c, embodies light chambers with the housing unit 28c, in particular with the second housing subelement 62c of the housing unit 28c. A number of light chambers and a number of lighting units 22c are substantially identical.

FIG. 20 shows an illumination strip 20d of an alternative hob device 10d. The illumination strip 20d has a light separating unit 66d. In an operating state, the light separating unit 66d is arranged within a housing unit 28d of the illumination strip 20d. In an operating state, the light separating unit 66d is arranged at a distance from a circuit board 30d of the illumination strip 20d in relation to a vertical direction 70d. In an operating state, the light separating unit 66d is retained and/or stored by the housing unit 28d, specifically in particular in a second housing subelement 62d of the housing unit 28d.

The light separating unit 66d has a large number of light separating elements 68d. Just one of the light separating elements 68d is described in the following. The light separating element 68d is assigned to a lighting unit 22d of the illumination strip 20d. In the present exemplary embodiment, the light separating unit 66d is embodied in one piece. The light separating unit 66d has a base body 90d. The base body 90d is plate-shaped. The base body 90d has an elongated shape. The light separating element 68d is embodied as a recess and/or as an opening and/or as a hole in the base body 90d. An embodiment of the light separating unit 66d of this type is referred to as a “pinhole application”.

FIG. 21 shows an illumination strip 20e of an alternative hob device 10e. The illumination strip 20e has a light separating unit 66e. In an operating state, the light separating unit 66e is arranged within a housing unit 28e of the illumination strip 20e. In an operating state, the light separating unit 66e is arranged on a circuit board 30e of the illumination strip 20e in relation to a vertical direction 70e. In an operating state, the light separating unit 66e is retained and/or stored by the circuit board 30e, specifically in particular indirectly or directly.

The light separating unit 66e has a large number of light separating elements 68e. In the present exemplary embodiment, the light separating unit 66e is embodied in multiple pieces. A number of light separating elements 68e and a number of lighting units 22e of the illumination strip 20e are identical. Just one of the light separating elements 68e and just one of the lighting units 22e is described in the following.

The light separating element 68e is assigned to the lighting unit 22e of the illumination strip 20e. In an operating state, the light separating element 68e is largely arranged above the lighting unit 22e in relation to a vertical direction 70e. In the present exemplary embodiment, the light separating element 68e is embodied as a collimator.

### REFERENCE CHARACTERS

10 Hob device
12 Placement plate
14 Item of cookware
16 Heating unit
18 Direction
20 Illumination strip
22 Lighting unit
24 Longitudinal extension
26 Depth extension
28 Housing unit
30 Circuit board
32 Diffusion unit
34 Seal unit
36 Lighting region
38 Further lighting unit
40 Hob outer housing unit
42 Storage space
44 Fastening element
46 Hob housing base
48 Hob
50 User interface
52 Control unit
54 Depth direction
56 Longitudinal extension direction
58 Diffusion unit retaining element
60 First housing subelement
62 Second housing subelement
64 Fastening means
66 Light separating unit
68 Light separating element
70 Vertical direction
72 Keep-clear element
74 Extension
76 Direction of movement
78 First placement position
80 Second placement position
82 Cooking system
84 Actuation connection
86 Extension
88 Insertion direction
90 Base body

1-15. (canceled)

16. A hob device, in particular induction hob device, said hob device comprising:
a placement plate configured for placement of an item of cookware;
at least two heating units configured to heat the item of cookware; and
an illumination strip including a lighting unit and configured to indicate in an operating state an extension of the item of cookware in relation to at least one direction.

17. The hob device of claim 16, wherein the illumination strip has a longitudinal extension of at least 200 mm.

18. The hob device of claim 16, wherein the illumination strip extends at least substantially over an entire depth extension of the placement plate.

19. The hob device of claim 16, wherein the illumination strip, in the operating state, indicates at least one position of the item of cookware in relation to the at least one direction.

20. The hob device of claim 16, wherein the lighting unit is embodied as a colored lighting unit and configured to emit light with at least two colors.

21. The hob device of claim 16, wherein the illumination strip has a further lighting unit configured for actuation independently of the lighting unit.

22. The hob device of claim 16, wherein the illumination strip, in the operating state, indicates a heating state of the item of cookware.

23. The hob device of claim 16, wherein the illumination strip, in the operating state, indicates a direction of movement, in which the item of cookware is movable.

24. The hob device of claim 23, wherein the illumination strip, in the operating state, indicates the direction of movement by means of a lighting intensity curve.

25. The hob device of claim 16, wherein the illumination strip, in the operating state, indicates a movement of the item of cookware from a first placement position to a second placement position.

26. The hob device of claim 25, wherein the illumination strip, in the operating state, indicates the movement of the item of cookware by deactivating the illumination of the first placement position and activating an illumination of the second placement position.

27. The hob device of claim 26, wherein the illumination strip, in the operating state, indicates an operating prompt, before activating the illumination of the second placement position, by at least a changing of an illumination property.

28. A hob, in particular induction hob, said hob comprising a hob device comprising a placement plate configured for placement of an item of cookware, at least two heating units configured to heat the item of cookware, and an illumination strip including a lighting unit and configured to indicate in an operating state an extension of the item of cookware in relation to at least one direction.

29. A cooking system, comprising:
an item of cookware; and
a hob comprising a hob device which includes a placement plate configured for placement of the item of cookware, at least two heating units configured to heat the item of cookware, and an illumination strip including a lighting unit and configured to indicate in an operating state an extension of the item of cookware in relation to at least one direction.

29. A cooking system, comprising a hob as set forth in claim 28, and an item of cookware.

30. A method for operating a hob device, said method comprising indicating in an operating state of the hob device an extension of an item of cookware on a placement plate of the hob device in relation to at least one direction by an illumination strip.

31. The method of claim 30, wherein the illumination strip, in the operating state, indicates at least one position of the item of cookware in relation to the at least one direction.

32. The method of claim 30, wherein the illumination strip emits light with at least two colors.

33. The method of claim 30, further comprising indicating, in the operating state, by the illumination strip a heating state of the item of cookware.

34. The method of claim 30, further comprising indicating, in the operating state, by the illumination strip a direction of movement of the item of cookware.

35. The method of claim 34, wherein the illumination strip, in the operating state, indicates the direction of movement by means of a lighting intensity curve.

36. The method of claim 30, further comprising indicating, in the operating state, by the illumination strip a movement of the item of cookware from a first placement position to a second placement position.

37. The method of claim 36, wherein the illumination strip, in the operating state, indicates the movement of the item of cookware by deactivating the illumination of the first placement position and activating an illumination of the second placement position.

38. The method of claim 37, wherein the illumination strip, in the operating state, indicates an operating prompt, before activating the illumination of the second placement position, by at least a changing of an illumination property.
